(19) United States
(12) Patent Application Publication
(10) Pub. No.: US 2007/0215300 A1
(43) Pub. Date: Sep. 20, 2007

(54) Solvents For Use In The Treatment Of Lignin-Containing Materials

(76) Inventors: Jonathan Upfal, Victoria (AU); Douglas Robert MacFarlane, Victoria (AU); Stewart Alexander Forsyth, Belfast (IE)

Correspondence Address: HOFFMANN & BARON, LLP, 6900 JERICHO TURNPIKE, SYOSSET, NY, 11791, US

(21) Appl. No.: 10/567,638

(22) PCT Filed: Aug. 13, 2004
(86) PCT No.: PCT/AU04/01093

§ 371 Date: Jun. 14, 2006

(30) Foreign Application Priority Data
Aug. 13, 2003 (AU) 2003904323

(51) Int. Cl. C09K 3/00; D21C 11/00

(52) U.S. Cl. 162/29; 162/100; 162/70

(57) ABSTRACT

A method for the treatment of a lignin-containing material such as wood pulp, bagasse and other plant-derived materials, comprising contacting the lignin-containing material with an ionic liquid to extract the lignin therefrom. The ionic liquid is suitably a substituted or unsubstituted imidazolium, triazolium, pyrazolium, pyridinium, pyrrolidinium, piperidinium, ammonium, phosphonium or sulfonium salt of a substituted or unsubstituted aryl sulfonate, such as an ionic liquid salt of a xylene sulfonate.

### FIELD OF INVENTION

The present invention relates to solvents for use in the treatment of lignin-containing materials, including lignocellulosic materials. Such materials include plant matter and plant matter derivatives. The present invention further relates to methods for extracting useful products from lignin-containing materials, including lignin and optionally other products, and the products obtained by such methods. The present invention additionally relates to new chemical species found to be suitable for use in these processes.

### BACKGROUND OF INVENTION

Plant products, which are ligno- and lignocellulosic materials, are used by man in the production of a number of different valuable commodities.

However, the lignocellulostic residues that are produced in large volumes from agricultural cropping of sugar, wheat, rice and corn, for example, are largely considered of little value and, if not collected, are often plowed-in, burnt or otherwise discarded. Some efforts have been made to extract useful materials from such waste lignocellulosic material (biomass). Examples of these processes utilize pretreatment with heat and chemicals followed by enzymatic digestion, or the application of concentrated mineral acids, to extract fermentable sugars and lignin. The derived sugars are intended to provide a feedstock for conversion into a renewable source of greenhouse gas neutral liquid fuels such as ethanol, or other valuable industrial and fine chemicals. Processes contemplated to achieve this have a number of similarities to wood pulping processes, as they may involve fractionation and separation of the lignin content from the cellulose, although in the case of the biomass the digestion conditions are more extreme so as to also cause the ultimate breakdown of the cellulose content into smaller chemical products.

There is room for improvement on the known processes for the treatment of lignin-containing material, including the wood pulping methods (the kraft pulping method being most common) and the lignocellulosic biomass treatments.

Novel pulping processes should:
Manage suitably prepared hardwood, softwood and herbaceous raw materials
Not degrade cellulose and hemicelluloses
Preferably require lower temperatures, pressures and pulping times than are usual in conventional pulping
Utilize known and tested engineering methods and equipment already perfected for conventional pulping, wherever possible
Have an optimal size smaller than that of a typical pulp mill.

In addition, the resulting pulp should:
Be directly substitutable by current end-users for conventional pulps with equivalent properties
Be readily bleachable
Offer high yield
Allow valuable by-products to be recovered.

Finally, the process should:
Have efficient and simple chemical recycling systems
Close the chemical cycle of the process, with little or no make-up chemical consumption
Have low specific energy consumption
Avoid malodorous emissions by being totally sulphur free
Permit complete recovery of process water with minimal discharge
For occupational health and safety, product residue, environmental, and other regulatory and public policy requirements, employ known chemicals that have negligible or low human and environmental toxicity, be non-flammable and non-explosive
Facilitate economic, environmental and other efficiencies in existing conventional pulping mills, if possible

Various “organosolv” processes have been contemplated as alternatives for the kraft process for the treatment of lignin-containing materials. Few, if any, of these have satisfied enough of the criteria outlined above to be commercially feasible.

The proposed processes for extracting lignin from waste lignocellulosic biomass have also suffered from disadvantages that have prevented any significant commercial adoption of the processes to date.

In the late 1950s McKee (CA 631,051) developed an “organosolv” alternative to kraft pulping which involved pulping under elevated temperature and pressure with a hydrotropic mixture of water and the crystalline salt sodium xylenesulphonate.

While this process appeared to offer some advantages over conventional pulping methods, it still suffered from a number of drawbacks. Under this process, a maximum of 40% of the salt is used in the solvent mixture, and with this hydrotropic system, the maximum temperature that can be attained under atmospheric pressure conditions is not much higher than the boiling point of water. As a consequence of this, to obtain sufficiently extreme conditions to break down the woody material into lignin and other byproducts including furfural and acetic acid, it is necessary to conduct the process at elevated pressure. The equipment required to achieve this introduces higher costs and design complications into the process, and makes it difficult to conduct the process continuously.

Consequently, there is room for improvement on the various processes known in the art for the treatment of lignin-containing materials.

### BRIEF SUMMARY

The present invention relates to the application of ionic liquids (preferably salts of acids with aryl functionality) as solvents or additives for treating (for example, dissolving, digesting, extracting and/or isolating materials from) natural sources or materials such as lignin-containing materials, including biomass.

Thus, according to a first aspect of the present invention, there is provided a method for the treatment of a lignin-containing material comprising the step of contacting the lignin-containing material with an ionic liquid.

Preferably, the method further comprises the step of extracting lignin from the lignin-containing material into the ionic liquid, and recovering the lignin from the ionic liquid. The material remaining after the lignin has been extracted is either cellulosic fibre that can be further processed into pulp for conversion to paper, or fully degraded to fermentable sugar monomers, or may be referred to as a waste material. According to one embodiment, the cellulosic fibre or waste material is separated from the ionic liquid following extraction of the lignin into the ionic liquid.

According to a second aspect of the present invention, there is provided the use of an ionic liquid in the treatment of a lignin-containing material.

According to a third aspect of the present invention, there is provided a product produced by the process described above.

Certain ionic liquids contemplated for use in the process of the present invention are novel per se, and therefore according to a fourth aspect of the present invention there is provided an ionic liquid comprising:
an substituted or unsubstituted aryl organic acid anion; and
an ionic liquid-forming inorganic cation or an organic cation.

Thus, the present invention also provides the use of the novel ionic liquids in the treatment of natural materials, such as plant materials and plant-derived materials.

### BRIEF DESCRIPTION OF THE FIGURES

FIG. 1 is a schematic illustration of a process according to one embodiment of the invention.

### DETAILED DESCRIPTION

Ionic Liquid

Ionic liquids are organic salts with low melting points (up to 100° C.), many of which are consequently liquid at room temperature. Specific features that make ionic liquids suitable for use in the present invention are their lack of vapor pressure, their ability to dissolve a wide range of organic compounds and the versatility of their chemical and physical properties. In addition, ionic liquids are non-flammable, which makes them suitable for use in the industrial applications contemplated by the present application.

It has been found that, in addition to these beneficial properties, when contacted with lignin-containing materials such as lignocellulosic materials, including plant matter and plant matter derivatives, the ionic liquids are capable of penetrating these materials, and removing the lignin therefrom. In addition, with the appropriate choice of treatment conditions (for example, time of contact and temperature), ionic liquids penetrate the structure of the lignin-containing material to break the material down to extract further organic species making up the lignin-containing material. Any cellulosic component remaining in the lignocellulosic material is preserved. Once separated from the ionic liquid liquor, the cellulosic component may then be optionally broken down into smaller organic compounds such as hexose and pentose sugars, which can be converted into fuel sources such as ethanol.

Although not wishing to be bound by theory, it is also believed that the ionic liquids contemplated for use in these applications have surfactant behaviour and/or catalytic ability that make them particularly useful in various embodiments.

Further, ionic liquids remain liquid at high temperatures without evaporating, when used alone or in high concentrations with a cosolvent. Thus, the ionic liquids can be used in the treatment of lignin-containing materials at high temperature, without the necessary application of pressure. Additional advantages of certain preferred ionic liquids are their ease of handling and low toxicity.

The ionic liquid may be a single species, or may be a mixture of different ionic liquid species. The ionic liquid may be used alone, or in combination of a cosolvent. Suitable cosolvents include water and organic solvents such as alcohols, ethers, acids and so forth. Water is particularly suitable.

According to one embodiment, the ionic liquid comprises:
an substituted or unsubstituted aryl organic acid anion; and
an ionic liquid-forming inorganic cation or an organic cation.

Anion

Regarding the anion component, the term aryl denotes single, polynuclear, conjugated and/or fused residues of aromatic hydrocarbon or aromatic heterocyclic ring system. Examples of aryl include phenyl, biphenyl, terphenyl, quaterphenyl, phenoxyphenyl, naphtyl, tetrahydronaphthyl, anthracenyl, dihydroanthracenyl, benzanthracenyl, dibenzanthracenyl, phenanthrenyl, fluorenyl, pyrenyl, indenyl, azulenyl, chrysenyl, pyridyl, 4-phenylpyridyl, 3-phenylpyridyl, thienyl, furyl, pyrryl, pyrrolyl, furanyl, imadazolyl, pyrrolydinyl, pyridinyl, piperidinyl, indolyl, pyridazinyl, pyrazolyl, pyrazinyl, thiazolyl, pyrimidinyl, quinolinyl, isoquinolinyl, benzofuranyl, benzothienyl, purinyl, quinazolinyl, phenazinyl, acridinyl, benzoxazolyl, benzothiazolyl and the like. If the aryl in the case of the anion is an aromatic heterocyclic ring system, this suitably contains 1 to 4 heteratoms independently selected from N, O and S and up to 9 carbon atoms in the ring. The aromatic functionality of the aryl organic acid anion may include any hetero-atoms, branched and/or ring fragments with the substituent promoting the solvent properties and/or physical properties of the corresponding ionic liquid.

According to one embodiment, the aryl is a hydrocarbon (ie non-heterocyclic) aryl group, typically phenyl or napthyl.

The aryl may be unsubstituted or substituted by one or more substitutents. Suitably substitutents may be selected from one or a combination of alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitrile, nitroalkyl, nitroalkenyl, nitroalkynyl, nitroaryl, nitroheterocyclyl, amino, imino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulphonyloxy, arylsulphenyloxy, heterocyclyl, heterocycloxy, heterocyclamino, haloheterocyclyl, alkylsulphenyl, arylsulphenyl, carboalkoxy, carboaryloxy, mercapto, alkylthio, benzylthio, acylthio, organic acid or ester such as sulfonate, and the like.

When a substituted aryl is used (preferably phenyl, napthyl or pyridyl), there are suitably between 1 and 4 substituents, and these are preferably independently selected from the group consisting of alkyl, hydroxy, amino and halo. More preferably the substituents are alkyl. According to one particular embodiment, the substituents are methyl.

The term “alkyl” denotes straight chain, branched or mono- or poly- cyclic alkyl, preferably C1-30 alkyl or cycloalkyl. Examples of straight chain and branched alkyl include methyl, ethyl, propyl, isopropyl, butyl, isobutyl, tert-butyl, hexyl, octyl, dodecyl, 1-methylundecyl and the like. The term halo encompasses chloro, iodo, fluoro and bromo.

The term “organic acid” in the context of the anion component of the ionic liquid refers the organic acids of sulfur, carbon and phosphorous, and therefore the anion species of these acids (i.e. in which the proton of the acid is removed) encompasses the sulfonates, sulfates, carboxylates, phosphinates, phosphates and so forth. The sulfonates (the anion of the organic acid sulfonic acid) is the subject of a number of embodiments of the present invention. It is noted that the anion may contain more than one organic acid group—such as the aryl disulfonate anions.

The ionic liquid of one embodiment is thus a salt of arylsulfonic acids. The anions of Formula 1 are examples of this class.

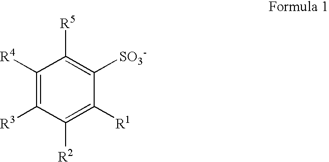

In this structure R¹, R², R³, R⁴, R⁵ are each independently selected from the group consisting of hydrogen, alkyl (including but not limited to methyl, ethyl, dodecyl), alicyclyl, aryl (including but not limited to benzyl and naphthyl), aralkyl, alkylaryl, heteroaryl, halogeno, haloaryl and sulfonate. In the case of sulfonate, the dianion may be partially or fully neutralised.

Other examples of anions that may be used are represented below.

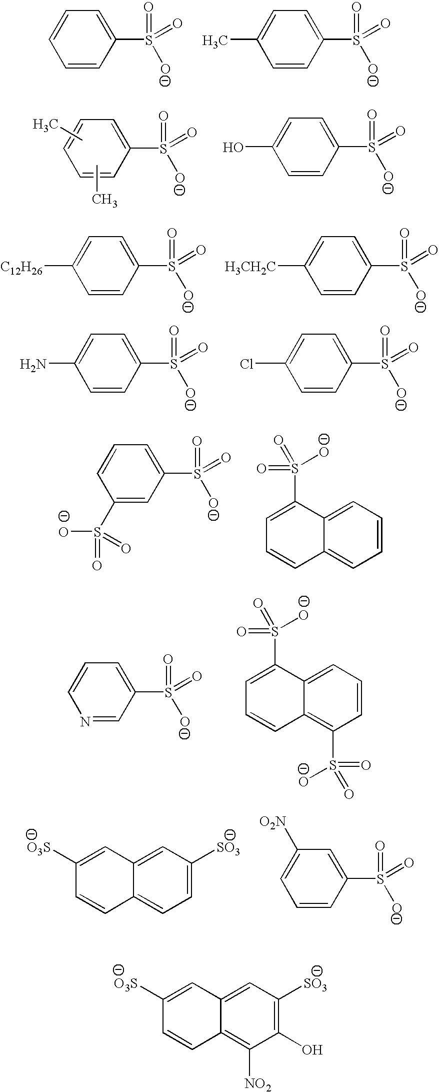

The sulfonates are a particularly useful class of the substituted or unsubstituted aryl organic acid anions. The results set out in the Examples below show that ionic liquids containing anions based on aryl sulfonate group (substituted or unsubstituted) are particularly effective in extracting lignin from the lignin-containing materials.

Cation

The cation component is either an ionic liquid-forming inorganic cation or an organic cation.

Regarding inorganic cations, it will be understood that simple alkali metals or alkaline earth metal cations that form crystalline salts with the anion component are not within the scope of the present invention, and therefore Na salts are excluded. Suitable inorganic cations include the rare earth metals.

Amongst the organic cations, the present invention encompasses substituted or unsubstituted imidazolium, triazolium, pyrazolium, pyridinium, pyrrolidinium, piperidinium, phosphonium equivalents of the above-mentioned groups, ammonium, phosphonium and sulfonium cations. In the case of substituted cations, the substituents are preferably selected from one or more of the optional substituents referred to above in the context of the anions, but they are preferably selected from hydrogen, aliphatic (i.e. optionally substituted alkyl, alkenyl, alkynyl), alicyclyl, aryl, aralkyl, alkylaryl, heteroaryl, haloaryl.

Some representative examples of the cations encompassed are the cations of Formulae 2 (2a, 2b and 2c) and 3:

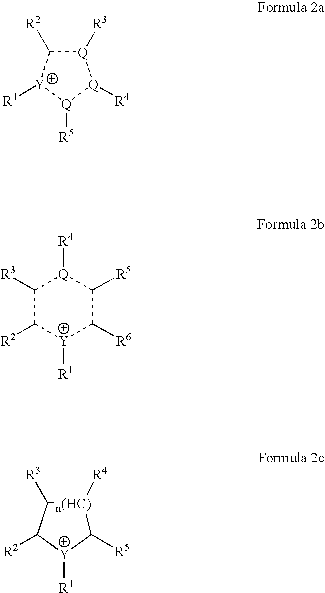

in which:

the dotted lines represent single or double bonds;

Q represents N, CH, O or S, and wherein when X represents O or S, the group R is absent and the adjoining bonds are single bonds;

Y represents N or P; and

n is 1 or 2

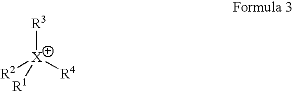

wherein:

X represents N, P or S;

R¹ to R⁴, are each independently selected from aliphatic (i.e. optionally substituted alkyl, alkenyl, alkynyl), alicyclyl, aryl, aralkyl, alkylaryl, heteroaryl and haloaryl.

Choline and derivatives thereof are other examples of suitable cations.

Further Components Which May Be Included in Mixture with Ionic Liquid Contacted with Lignin-Containing Material

The salts which are the subject of this invention, are generally liquids at some temperature below 250° C. either in their pure state or when mixed with one or more other salts. The salts that may be mixed with the ionic liquid may be a second ionic liquid as described above, or any other known ionic liquid.

The ionic liquids may be used as solvents or additives. When used as a solvent, the solvent may also include a further component which is a molecular solvent such as water, ethanol, toluene and other solvents well known in the field of chemistry. In some embodiments of the invention, the ionic liquid may constitute between 50 and 100% of the solvent composition, for instance between 70% and 100% of the solvent composition.

When used as a solvent, the solvent composition may be used in any suitable solvating amount with respect to the lignin-containing material. It may for instance be used in an amount of between 2 and 50 times the amount of lignin-containing material, based on weight.

Commonly used acids and bases may also be added to this solvent composition for simple pH management of optimal conditions or other advantageous effect. Such acids or bases may be present at weight percentages from 0.01% -90%. The pH may be controlled within the range 3.0 to 14.0, suitably 5.0 to 12.0, as required by the process. The more vigorous the conditions, in terms of pH, time and temperature, the greater the expected penetration of the lignin-containing material for the extraction of lignin and other extractable chemicals.

Any other components may be used in the solvent composition, including Na and/or Li salts, transition metal or other oxidation catalysts, air or molecular oxygen. Such components (including sodium xylene sulfonate) may be used for catalytic effect or otherwise. Such additives may be present at weight percentages from 0.01%-90%, suitably 0.01-10% by weight.

In an alternative application, the ionic liquids that are the subject of this invention may be used as additives, and therefore they may be added to the composition of conventional kraft alkali liquors to facilitate and accelerate removal of lignin. The new ionic liquids may be used in the treatment of any natural products to extract extractable chemicals therefrom.

Natural Sources and Lignin Containing Materials

The present invention is broadly applicable to the treatment of natural sources, including plant and plant-derived materials. This therefore encompasses lignin-containing materials. The term lignin-containing material encompasses, without limitation, plant derived biomass, corn stover, sugar cane bagasse and cane residues, rice and wheat straw, agricultural grasses, woodchips, bamboo, and all other materials proximately or ultimately derived from plants.

Lignin is a complex polymeric material (mostly comprised of phenolic groups, anisole, primary, secondary alcoholic groups and aldehydes) located in the woody cell wall that confer strength and rigidity to the woody cell. In the preparation of paper, the lignin is removed to leave the cellulosic material for formation into paper.

Processing Steps

The ionic liquid is used in the treatment of materials. Treatment encompasses dissolving, digesting, extracting and/or isolation of components therefrom.

One suitable treatment comprises contacting a lignin-containing material with the ionic liquid to extract lignin and optionally other chemicals into the liquid phase, and thereafter separating the liquid phase from remaining solids. In the case where the lignin-containing material is a lignocellulosic material, the remaining solids comprise cellulosic fibre.

The contacting stage is suitably conducted at an elevated temperature, and preferably at atmospheric pressure. Preferably the this stage is conducted at a temperature between 50 and 200° C., more preferably between 100-180° C., most preferably between 120-160° C. Preferably the time of contact is between 1 and 8 hours.

The lignin-containing material is contacted with the ionic liquid in a vessel, and the contents heated to the desired temperature by any suitable means. One suitable heater is a boiler, which may be powered by any fuel, such as the lignin recovered during downstream processing of the ionic liquid.

After separation of the liquid phase from the remaining solids, the process suitably comprises the step of precipitating lignin from the liquid phase. This maybe achieved by any of a number of ways, for example precipitation may be induced by adding water and/or varying temperature or pH. Alternatively, the liquid phase may be contacted with an immiscible organic solvent into which the lignin products report, or with a polyethylene glycol (PEG) solution to form an aqueous biphase system within which the lignin products will preferably move to the organic PEG phase. Thereafter the precipitated lignin is recovered from the liquid phase, for example by filtration, or from the immiscible organic solvent by distillation, or from the PEG phase of the biphasic system by pH adjustment followed by filtration.

The recovered lignin may be used as a fuel or feedstock for this or any other process.

Once the extractable chemicals such as lignin have been extracted into the ionic liquid, and thereafter removed, the ionic liquid can be recovered by any suitable means from the process liquor (i.e. re-concentrated and separated from contaminants), or alternatively reused directly. Recovery can be achieved by a number of methods, including, without limitation, salting out with an appropriate inorganic salt (e.g. Potassium phosphate salt), reverse osmosis,or solidification by temperature reduction. The last of these examples is of particular interest for ionic liquids with higher melting points. By reducing the extracted liquid phase temperature to a sufficiently low level, the ionic liquid is solidified in a non-crystalline form.

According to one embodiment of the invention, a separate stream of the liquid phase, from which the solids have been separated, is directly recycled to an upstream stage of the process for contacting with further lignin-containing material without any removal of lignin.

The diluted stream of ionic liquid, from which the precipitated lignin has been removed, may be dewatered to remove excess water (added during dilution) therefrom. Thereafter, the dewatered ionic liquid may be subjected to distillation to remove other chemicals extracted from the lignin-containing materials therefrom. These other chemicals may include acetic acid and/or furfural. Thereafter, the ionic liquid is recycled for contacting with further lignin-containing material.

Other Features of the Ionic Liquids

The new ionic liquids identified in the present application also display high electrochemical stability compared to conventional electrolytes. Typically large electrochemical windows are observed using cyclic voltammetry. Ionic liquids of this type are therefore also suitable for use as electrolytes, or ionic additives, for electrochemical applications such as electrowinning technologies. Any metal salt, including; copper, titanium, and aluminium, that can be dissolved in the ionic liquid and electrochemically reduced is potentially recoverable in the metallic form.

### EXAMPLES

The present invention will now be described in further detail with reference to the following non-limiting examples.

Synthesis of Novel Materials

Ionic liquids were generally prepared by heating constituent salts in toluene to allow a metathesis reaction to proceed to yield the target ionic liquid.

### Example 1

1-ethyl-3-methylimidazolium xylenesulfonate (EmImXS) was prepared by metathesis of sodium xylenesulfonate and 1-ethyl-3-methylimidazolium bromide.

EmImXS is a useful liquid salt for the extraction of lignin from pulp at temperatures around 150° C. in a solvent mixture which contains water and some residual sodium xyelenesulfonate.

The procedure for the production of EmImXS was the same as that used for the production of tetrabutylammonium xylenesulphonate (TBABXS) from tetrabutylammonium bromide and sodium xylenesulphonate, and tetrabutylammonium benzoate (TBABBz) from tetrabutylammonium bromide and sodium benzoate.

This procedure involved the following steps. Approximately equimolar amounts of 1-ethyl-3-methylimidazolium bromide or tetrabutylammonium bromide and sodium xylenesulphonate were added to a 2-litre round bottom flask. Toluene (600 ml, 5-6 times the mass of salts) and boiling chips were added to the flask. The flask was fitted with a condenser and the slurry was heated at reflux overnight. Upon cooling, the slurry was filtered to remove the sodium bromide metathesis product. The filtrate was evaporated to dryness on a rotary evaporator to give a thick viscous liquid. Acetone was added to the flask and the ionic liquid was dispersed with vigorous mixing. The solution was filtered and the filtrate was evaporated to dryness once more. The resultant ionic liquid was left to rotate on the rotary evaporator at a very low speed and at high temperature (−90° C.) to remove as much residual toluene as possible. The residual oil was then used as neat ionic liquid.

### Example 2

Trihexyltetradecylphosphonium xylenesulfonate (P66614XS) was prepared using two different methods.

In a first method, an ion-exchange column was loaded with xylenesulfonate anions and a solution of trihexyltetradecylphosphonium chloride was passed through several times until complete exchange was indicated by the lack of chloride ions in the eluent. 1Hnmr (CDCl₃) δ 0.85-0.95 (m, 12H, CH₃), 1.20-1.35 (m, 48H, CH₂), 1.40-1.60 (m, 14H, P—CH₂ & Ar—CH₃), 6.90-7.30 & 7.60-7.90 (m, 3H, CH).

Electrospray Mass Spec: ES+ 483 [P66614+1 m/z. ES− 185 [XS-] m/z.

According to the second method, trihexyltetradecylphosphonium chloride (P66614 chloride; 1.1 mole) was refluxed with 1 mole of sodium xylenesulfonate (NaXS) in toluene overnight. The product was filtered and toluene removed by rotary evaporation under vacuum to recover the ionic liquid. The ionic liquid was characterized by NMR/ES MS.

This phosphonium cation based hydrophobic ionic liquid was synthesised because it precludes water which may facilitate removal of inorganics such as silica into the water phase during extraction of lignocellulose materials and also would make it suitable for use in some noble metal electrochemical extraction applications. In addition, the asymmetric nature of cation produces a liquid substance at room temperature.

P66614XS was tested and found to display excellent thermal stability at 150° C. Thermogravimetric analysis indicates the loss of less than 0.2% volatile material during 4 hours at this temperature. Thermal decomposition temperature was calculated using the step-tangent method and found to be 310° C.

### Example 3

Tetrabutylammonium dodecylbenzenesulfonate N4444DDBS is prepared by neutralising an aqueous solution of dodecylbenzenesulfonic acid with tetrabutylammonium hydroxide and removing water by evaporation.

### Example 4

N-butyl-N-methylpyrrolidinium 4-hydroxybenzenesulfonate is prepared directly in one-pot by alkylating N-butylpyrrolidine with the methyl ester of 4-hydroxybenzenesulfonic acid.

### Example 5

Tetrabutyl ammonium xylenesulfonate (N4444 XS) was prepared by a reflux reaction between tetrabutyl ammonium bromide (N4444 Br) and sodium xylenesulfonate (solid) in toluene for 10-12 hours. The product was filtered and the toluene evaporated from the reaction mixture, followed by washing with acetone to yield the pure ionic liquid. 1H NMR (300 MHz, D₂O): ppm 0.9 (t, J=7.5 Hz, 12H, (CH₃CH₂CH₂CH₂)₄N), 1.12-1.26 (m, 8H, (CH₃CH₂CH₂CH₂)₄N), 1.4-1.54 (m, 8H, (CH₃CH₂CH₂CH₂)₄N), 2.18 (s, 3H, Xy-CH₃), 3.00 (S, 3H, Xy-CH₃), 3.01 (t, 8H, J=8.4 Hz (CH₃CH₂CH₂CH₂)₄N), 6.99-7.3 (m, 2H, Xy-H), 7.51-7.59 (m, 1H, Xy-H).

N4444 XS is a hydrophilic ionic liquid. Being hydrophilic, this ionic liquid can penetrate the wood chips and extract lignin effectively.

### Example 6

Phenyltrimethylammonium xylenesulfonate (Ph(Me)₃N XS) ionic liquid was prepared in a reflux reaction between phenyltrimethylammonium chloride (Ph(Me)₃N Cl) and sodium xylenesulfonate (NaXS; solid) in toluene for 10-12 hours. The product was filtered and evaporated toluene from the reaction mixture to yield a crude solid product. The crude ionic liquid was washed with DCM to remove impurities.

Testing and Use of Novel Materials

### Example 7

An extraction process was carried out as follows: A reaction vessel is charged with a solution of ionic liquid based solvent. Biomass such as wood chips or hebaceous material are added to the vessel. The mixture is heated and stirred for several hours. Solid cellulosic material is filtered and prepared for pulping to paper. Dilution of the filtrate after repeated digestion cycles with water precipitates lignin, which is collected. Distillation of the filtrate affords various volatile chemicals. The ionic liquid based solvent is recycled to the beginning of the process.

In the above process, the following specific conditions and materials were used.

Bagasse was used as a prototype biomass. Bagasse has the following average composition on a dry weight basis: Cellulose 41%; Hemicellulose 23.2%; Lignin 21.2%; Ash 10.9%; Extractives 4.5%

2.58 grams of sifted (2-3 mm mesh) bagasse was combined with 22.62 grams of tetrabutylammonium xylene sulphonate, 2.5 grams of water and sufficient acetic acid to bring the pH to 4.0 in a 100 ml round bottom flask. This mixture was subjected to an impregnation step, 90 minutes refluxing at 130° C. The temperature of the mixture was then increased to 160° C. by removing the reflux condenser to allow excess water to evaporate. The reflux condenser was replaced and the mixture subjected to digestion at 160° C. for 2 hours. Upon reaction termination the solid bagasse pulp was removed by filtration, the filter cake being subjected to washing with water (×2 100 ml) and acetone (×1 50 ml). All filtrates were then combined and 600 ml of warm water added to precipitate the extracted lignin and cellulose materials. This reaction produced 1.24 g of digested bagasse and 1.2 g of lignin/cellulose extract (95% mass retention).

### Example 8

### Extraction Trials

General Procedure.

The following procedure was used in the extraction trials, with the exception of P66614XS where the mass was reduced.

Ionic liquid was warmed to assist in its transfer to the reaction flask. The IL (˜90 g) was added to a 250-ml two-necked round bottom flask and the IL mass was recorded. Water (˜10 g) was added and the flask was swirled to mix the contents evenly. Acid or base was added to the flask as required and the amount of acid or base was recorded. Bagasse (˜10 g) was added and the flask was warmed to help ensure that the bagasse was thoroughly wetted by the IL solution. The flask was fitted with a reflux condenser (and a stopper in the second neck) and heated in an oil bath at reflux for 1 hour. The condenser was then replaced with a stillhead, to which the condenser was reattached. The temperature of the oil bath was then increased to drive the distillation of water and residual toluene from the reaction flask. The distillate was recovered in a tared collection flask. The temperature within the reaction flask rose to 150° C. and it was maintained in the range of 150°-160° C. for 2 hours. The distillation apparatus was then dismantled and the masses of the distillate and residue were recorded. The residue was diluted with acetone (200 ml) and filtered (Whatman no. 1) while still hot. The residual pulp was washed with further acetone until the filtrate appeared near colourless. The pulp was washed with water and more acetone and was then oven-dried. The combined filtrates were then evaporated to remove water and acetone, and the black oily residue that remained was weighed. It was assumed that this residue contained the recovered IL and the extracted lignin.

Results

The results for the cooking experiments are shown in Tables 1 and 2. Table I shows a general mass balance for each experiment, while Table 2 more specifically shows the performance in extracting lignin from bagasse and the recovery of the ionic liquid.

Notes
It is apparent from mass balance results obtained following digestion of the bagasse that the cellulose and hemicellulose in the pulp generally suffered little degradation, which indicates that ionic liquid pulping is highly selective for lignin extraction.
Lignin was not separated from the ionic liquid after separation from the pulp. The degree of lignin removal was calculated based on the Kappa number of the resultant pulp.
The high recovery of EMIMXS was related to the low toluene content in the ionic liquid before the cooking trial. Toluene was not collected in the distillate for the EMIMXS trials. In contrast, several grams of toluene was collected in the distillate for the trials using TBAXS and TBABz. This probably explains the yield of recovered XL for the TBAXS trials.
The results with TBABz were not as good as for the other ionic liquids. The smaller quantities of TBABz used in these trials also contributed to experimental inaccuracy for this ionic liquid. Furthermore, on completion of the trials with TBABz, a strong ester-like odour was evident, suggesting that some chemical transformation had occurred.

Acidic trials appeared to be more efficient as judged by eye and from the Kappa number results.

TABLE 1
Overall mass balance for ionic liquid extractions of bagasse

| | Bagasse in | Dry | | Added | Acid/ | | Total | | | | | Total | Overall |
|---|---|---|---|---|---|---|---|---|---|---|---|---|---|
| Ionic liquid | (wet)^{a} | bagasse | IL | water | base | pH | in | Residue | Pulp | IL + lignin | Distillate | out | loss (%) |
| EMIMXS | 10.03 | 6.50 | 90.04 | 10.17 | 0 | 6 | 110.24 | 98.69 | 5.61 | 92.62 | 7.28 | 105.51 | 4.29 |
| EMIMXS | 10.38 | 6.73 | 90.11 | 10.35 | 0.37 | 4 | 111.21 | 99.2 | 5.53 | 91.52 | 8.06 | 105.11 | 5.49 |
| TBAXS | 10.06 | 6.52 | 87.85 | 10 | 0.43 | 4.5 | 108.34 | 85.52 | 4.87 | 80.1 | 15.89 | 100.86 | 6.90 |
| TBAXS | 10.05 | 6.51 | 90.45 | 10 | 0 | 9 | 110.5 | 88.05 | 5.25 | 76.86 | 15.35 | 97.46 | 11.80 |
| TBABz | 3.94 | 2.55 | 35.03 | 3.94 | 0 | 7 | 42.91 | 31.22 | 1.97 | 17.29 | 5.72 | 24.98 | 41.79 |
| TBABz | 4.03 | 2.61 | 34.96 | 3.94 | 0.2 | 4.5 | 43.13 | 31.24 | 1.8 | 19.87 | 7.64 | 29.31 | 32.04 |
| P66614 XS | 0.724 | 0.47 | 6.29 | 0.715 | 0 | | 7.729 | 6.705 | 0.22 | 6.48 | 1 | 7.68 | 0.63% |

EMIMXS, ethylmethylimidazolium xylenesulphonate;
TBAXS, tetrabutylammonium xylenesulphonate;
TBABz, tetrabutylammonium benzoate;
P66614XS, trihexyltetradecylphosphonium xylene sulphonate
^{a}Bagasse moisture: 35.2%

TABLE 2
Efficiency in removal of lignin from bagasse and recovery of ionic liquids

| | Bagasse | | | | | | | | | Total | | | |
|---|---|---|---|---|---|---|---|---|---|---|---|---|---|
| Ionic | in | Dry | | | IL + | | Pulp | % Lignin in | Lignin in | available | Lignin | % Lignin | Recovered |
| liquid | (wet) | bagasse | pH | IL | lignin | Pulp | kappa | pulp^{a} | pulp | lignin^{b} | removed | removed | IL (%)^{c} |
| EMIMXS | 10.03 | 6.50 | 6 | 90.04 | 92.62 | 5.61 | 48.05 | 7.21 | 0.40 | 1.38 | 0.97 | 70.65 | 102% |
| EMIMXS | 10.38 | 6.73 | 4 | 90.11 | 91.52 | 5.53 | 61.1 | 9.17 | 0.51 | 1.43 | 0.92 | 64.46 | 101% |
| TBAXS | 10.06 | 6.52 | 4.5 | 87.85 | 80.1 | 4.87 | 55.6 | 8.34 | 0.41 | 1.38 | 0.98 | 70.61 | 90% |
| TBAXS | 10.05 | 6.51 | 9 | 90.45 | 76.86 | 5.25 | 60.9 | 9.14 | 0.48 | 1.38 | 0.90 | 65.26 | 84% |
| TBABz | 3.94 | 2.55 | 7 | 35.03 | 17.29 | 1.97 | 57.9 | 8.69 | 0.17 | 0.54 | 0.37 | 68.39 | 48% |
| TBABz | 4.03 | 2.61 | 4.5 | 34.96 | 19.87 | 1.8 | 53 | 7.95 | 0.14 | 0.55 | 0.41 | 74.15 | 56% |
| P66614XS | 0.724 | 0.47 | 7 | 6.29 | 6.46 | 0.22 | 41.4 | 6.21 | 0.01 | 0.10 | 0.09 | 86% | 101% |

^{a}Based on formula (% lignin = 0.15 × Kappa no.)
^{b}Assumed lignin content in bagasse −21.2% on dry weight
^{c}Based on lignin recovery as calculated by Kappa number determination

### Example 9

### Continuous Process

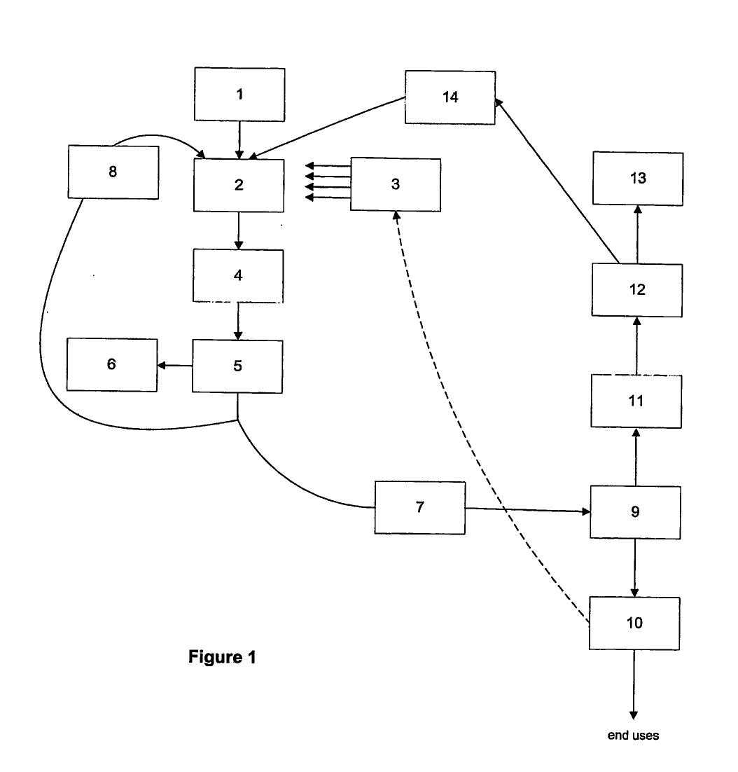

FIG. 1 illustrates a continuous process for conducting the process of one embodiment of the invention.

Biomass is prepared 1 and fed into a digestor 2 together with ionic liquid from two different sources, as will be described in further detail below.

The digester 2 is heated by a boiler 3. The lignin is extracted from the biomass into the ionic liquid in the boiler. Thereafter, the material from the digester is washed/refined 4, and subjected to solid/liquid separation 5. The solid cellulosic fibre is recovered 6 and used for paper production or similar. The ionic liquid is separated into two streams—a first stream (⅔ of the ionic liquid) being recycled 7 to the digester 2, and the second (⅓ of the ionic liquid) being sent to lignin precipitation process step 8. The precipitated lignin is separated from the ionic liquid by liquid/solid separation 9, and the lignin recovered 10 for various end uses. One possible use represented by the dashed line is as fuel for the boiler 3. The ionic liquid is then dewatered 11, prior to distillation/concentration 12 to recover organic byproducts 13 such as furfural and acetic acid. Water removed during dewatering 11 is recycled to the washing/refining stage 4. The ionic liquid from the distillation/concentration stage is regenerated 14 for recycling to the digester 2.

It will be understood to persons skilled in the art that many modifications may be made to the embodiments and Examples described above without departing from the spirit and scope of the invention.

What is claimed is:

1. A method for the treatment of a lignin-containing material comprising contacting the lignin-containing material with an ionic liquid to extract the lignin into the ionic liquid.

2. The method of claim 1, wherein the lignin from the lignin-containing material extracted into the ionic liquid is recovered from the ionic liquid.

3. The method of claim 2, wherein solids remaining after the lignin has been extracted into the ionic liquid are separated from the ionic liquid.

4. The method of claim 1, wherein the lignin-containing material is contacted with a single species of ionic liquid.

5. The method of claim 1, wherein the lignin-containing material is contacted with a mixture of different ionic liquid species.

6. The method of claim 1, wherein the lignin-containing material is contacted with a combination of the ionic liquid and a cosolvent.

7. The method of claim 6, wherein the lignin-containing material is contacted with a combination of the ionic liquid and water.

8. The method of claim 1, wherein the lignin-containing material is contacted with a solvent composition comprising between 50 and 100% of the ionic liquid.

9. The method of claim 1, wherein the ionic liquid comprises:
a substituted or unsubstituted aryl organic acid anion; and
an ionic liquid-forming inorganic cation or an organic cation.

10. The method of claim 9, wherein the anion component of the ionic liquid is a substituted or unsubstituted phenyl, naphthyl or pyridyl organic acid anion.

11. The method of claim 10, wherein the aryl organic acid anion is substituted with 1 to 4 substituents independently selected from the group consisting of alkyl alicyclyl, aryl, aralkyl, alkylaryl, heteroaryl, halogeno, hydroxy, nitro, haloaryl and sulfonate.

12. The method of claim 9, wherein the organic acid anion is a sulfonate, sulfate, carboxylate, phosphinate or a phosphate.

13. The method of claim 9, wherein the organic acid anion is a sulfonate.

14. The method of claim 9, wherein the anion is a substituted or unsubstituted aryl disulfonate anion.

15. The method claim 9, wherein the cation of the ionic liquid is a substituted or unsubstituted imidazolium, triazolium, pyrazolium, pyridinium, pyrrolidinium, piperidinium, phosphonium equivalents of one of the preceding groups, an ammonium, phosphonium or sulfonium cation.

16. The method of claim 15, wherein the cation is substituted by one or more selected from the group consisting of aliphatic, alicyclyl, aryl, aralkyl, alkylaryl, heteroaryl, hydroxy, nitro and haloaryl.

17. The method of claim 1, wherein the ionic liquid is a substituted or unsubstituted imidazolium, triazolium, pyrazolium, pyridinium, pyrrolidinium, piperidinium, ammonium, phosphonium or sulfonium salt of a substituted or unsubstituted aryl sulfonate.

18. The method of claim 1, wherein the lignin-containing material is contacted with a kraft alkali liquor in the presence of an ionic liquid additive.

19. The method of claim 1, wherein the lignin-containing material is a ligno-cellulosic material.

20. The method of claim 19, wherein the lignin is selectively extracted into the ionic liquid, without significant degradation of the cellulose and hemicellulose of the ligno-cellulosic material.

21. The method of claim 1, wherein the lignin-containing material comprises a plant or plant derivative material.

22. The method of claim 1, wherein the lignin-containing material is selected from one or more of lignocellulostic residues of sugar, wheat, rice and corn or other biomass, agricultural grasses, woodchips, bamboo, as well as any materials proximately or ultimately derived from plants.

23. The method of claim 1, comprising contacting the lignin-containing material with the ionic liquid to extract the lignin and optionally other chemicals into the liquid phase, and separating the liquid phase from remaining solids.

24. The method of claim 23, wherein the lignin-containing material is a lignocellulosic material, and the remaining solids comprise cellulosic fibre.

25. The method of claim 23, wherein the lignin-containing material is contacted with the ionic liquid at an elevated temperature.

26. The method of claim 25, wherein the elevated temperature is between 50 and 200° C.

27. The method of claim 26, wherein the lignin-containing material is contacted with the ionic liquid at atmospheric pressure.

28. The method of claim 23, wherein the time of contact is between 1 and 8 hours.

29. The method of any one of claims 23 claim 23, further comprising precipitating the lignin from the liquid phase after separation of the liquid phase from the remaining solids.

30. The method of claim 29, further comprising recovering the precipitated lignin from the liquid phase.

31. The method of claim 30, further comprising dewatering the diluted stream of ionic liquid, from which the precipitated lignin has been removed, to remove excess water therefrom.

32. The method of claim 31, further comprising distilling the dewatered ionic liquid to remove other chemicals extracted from the lignin-containing materials therefrom.

33. The method of claim 32, further comprising recycling the ionic liquid recovered following distillation for contacting with further lignin-containing material.

34. The product produced by the method of claim 1.

35. A method of using an ionic liquid in the treatment of a lignocellulosic material to extract lignin into the ionic liquid and preserve the cellulosic fibre comprising the step of contacting the ionic liquid with the lignocellulosic material.

36. The method of claim 35, wherein the ionic liquid comprises:
an substituted or unsubstituted aryl organic acid anion; and
an ionic liquid-forming inorganic cation or an organic cation.

37. The method of claim 36, wherein the anion component of the ionic liquid is a substituted or unsubstituted phenyl, naphthyl or pyridyl organic acid anion.

38. The method of claim 36, wherein the aryl is substituted by between 1 and 4 substituents independently selected from the group consisting of alkyl, alicyclyl, aryl, aralkyl, alkylaryl, heteroaryl, halogeno, hydroxy, nitro, haloaryl and sulfonate.

39. The method of claim 35, wherein the organic acid anion is a sulfonate, sulfate, carboxylates, phosphinate or a phosphate.

40. The method of claim 35, wherein the organic acid anion is a sulfonate.

41. The method of claim 35, wherein the anion is a substituted or unsubstituted aryl disulfonate anion.

42. The method of claim 35, wherein the cation of the ionic liquid is a substituted or unsubstituted imidazolium, triazolium, pyrazolium, pyridinium, pyrrolidinium, piperidinium, phosphonium equivalents of one of the preceding groups, an ammonium, phosphonium or sulfonium cation.

43. The method of claim 42, wherein the cation is substituted by one or more selected from the group consisting of aliphatic, alicyclyl, aryl, aralkyl, alkylaryl, heteroaryl, hydroxy, nitro and haloaryl.

44. The method of claim 43, wherein the ionic liquid is a substituted or unsubstituted imidazolium, triazolium, pyrazolium, pyridinium, pyrrolidinium, piperidinium, ammonium, phosphonium or sulfonium salt of a substituted or unsubstituted aryl sulfonate.

45. An ionic liquid comprising
an substituted or unsubstituted aryl organic acid anion; and
an ionic liquid-forming inorganic cation or an organic cation.

46. The ionic liquid of claim 45, wherein the anion component of the ionic liquid is a substituted or unsubstituted phenyl, naphthyl or pyridyl organic acid anion.

47. The ionic liquid of claim 45, wherein the aryl is substituted by between 1 and 4 substituents independently selected from the group consisting of alkyl, alicyclyl, aryl, aralkyl, alkylaryl, heteroaryl, halogeno, hydroxy, nitro, haloaryl and sulfonate.

48. The ionic liquid of claim 45, wherein the organic acid anion is a sulfonate, sulfate, carboxylates, phosphinate or a phosphate.

49. The ionic liquid of claim 45, wherein the organic acid anion is a sulfonate.

50. The ionic liquid of claim 45, wherein the anion is a substituted or unsubstituted aryl disulfonate anion.

51. The ionic liquid of claim 45, wherein the cation is a substituted or unsubstituted imidazolium, triazolium, pyrazolium, pyridinium, pyrrolidinium, piperidinium, phosphonium equivalents of one of the preceding groups, an ammonium, phosphonium or sulfonium cation.

52. The ionic liquid of claim 51, wherein the cation is substituted by one or more selected from the group consisting of aliphatic, alicyclyl, aryl, aralkyl, alkylaryl, heteroaryl, hydroxy, nitro and haloaryl.

53. An ionic liquid comprising a substituted or unsubstituted imidazolium, triazolium, pyrazolium, pyridinium, pyrrolidinium, piperidinium, ammonium, phosphonium or sulfonium salt of a substituted or unsubstituted aryl sulfonate.

54. The ionic liquid of claim 53, wherein the substituted or unsubstituted aryl sufonate is a substituted or unsubstituted phenyl, napthyl or pyridyl sulfonate.

55. The ionic liquid of claim 53, wherein the substituents of the aryl sulfonate component are selected from the group consisting of aliphatic, alicyclyl, aryl, aralkyl, alkylaryl, heteroaryl, hydroxy, nitro and haloaryl.

56. A method of using the ionic liquid of claim 45 in the treatment of a natural material, comprising the step of contacting the ionic liquid with the natural material.

57. The method of claim 56, wherein the natural material comprises plant materials and plant-derived materials.
